(19) United States
(12) Patent Application Publication
(10) Pub. No.: US 2014/0334288 A1
(43) Pub. Date: Nov. 13, 2014

(54) WIRELESS TAP-OFF DEVICE CAPABLE OF PROVIDING WIRELESS LAN SERVICE

(71) Applicant: Sung Hun Hong, Goyang-si (KR)

(72) Inventor: Sung Hun Hong, Goyang-si (KR)

(73) Assignee: NETWAVE CO., LTD., Bucheon-si, Gyeonggi-do (KR)

(21) Appl. No.: 14/372,561

(22) PCT Filed: Jan. 16, 2012
(86) PCT No.: PCT/KR2012/000345

§ 371 Date: Jul. 16, 2014

(51) Int. Cl. H04W 24/04

(52) U.S. Cl. CPC H04W 24/04; H04W 84/12
USPC 370/216

(57) ABSTRACT

A wireless tap-off device capable of providing a wireless LAN service, which can allow a user to receive a wireless LAN service anywhere in the country through a tap-off device of an existing CATV network, is provided. The wireless tap-off device may include a cable modem which converts a CATV signal into an Ethernet signal, outputs the converted signal, converts an Ethernet signal into a CATV signal, and transmits the converted signal to a connector, an access point which converts an Ethernet signal applied from the cable modem into a wireless signal, transmits the converted signal to a computer device through an antenna in a wireless manner, converts a wireless signal applied from the computer device into an Ethernet signal, and provides the converted signal to the cable modem, a DC power supply, and a switching unit.

### TECHNICAL FIELD

The present invention relates to a wireless tap-off device capable of providing a wireless LAN service, which can allow a user to receive a wireless LAN service anywhere in the country through a tap-off device of an existing CATV network.

### BACKGROUND ART

Generally, a wireless local area network (hereinafter referred to as a wireless LAN) is a LAN system which performs data transmission and reception between computers or between a computer and a communication system in a wireless manner using radio frequency (RF) or infrared (IR) technology. The wireless LAN system is configured to be connected to a subscriber terminal through an existing CATV network.

FIG. 1 is a schematic diagram showing the configuration of a conventional wireless LAN system, in which a service providing server 10 for providing a wires LAN service is connected to an IP network 20 which is connected to a CATV network 40 through a head-end device 30. Communication channels between the IP network 20 and a plurality of subscriber terminals 50 are formed by a tap-off device 41 as a terminal of the CATV network 40. The head-end device 30 serves as a data interface between the IP network 20 and the CATV network 40.

The tap-off device 41 is installed at the top of telephone poles located all over the country at present. As shown in FIG. 2, the tap-off device 41 comprises a balun 411, a filtering processing unit 412, a splitter 413, and a plurality of connectors 414 connected to the subscriber terminals 50. The balun 411 outputs a signal applied from the head-end device 30 through the CATV network 40 to another tap-off device or to the filtering processing unit 412 and provides a CATV signal applied from the filtering processing unit 412 to the head-end device 30 through the CATV network 40.

Meanwhile, the subscriber terminal 50 in FIG. 1 comprises, as shown in FIG. 3, a cable modem 51 connected to the connector 414 of the tap-off device 41 through a predetermined cable C, an access point 52, at least one wireless terminal device 53 composed of a personal computer, for example, and a power supply 54 for supplying DC power to the cable modem 51 and the access point 52. Here, the cable modem 51 converts a CATV signal into an Ethernet signal and transmits the converted signal to the access point 52. Moreover, the cable model 51 converts an Ethernet signal into a CATV signal and transmits the converted signal to the tap-off device 41. The access point 52 converts an Ethernet signal into a wireless signal and transmits the converted signal to the wireless terminal device 53 through a predetermined antenna. Moreover, the access point 52 converts a wireless signal applied from the wireless terminal device 53 into an Ethernet signal. The wireless terminal device 53 is equipped with a wireless LAN card for transmitting and receiving the wireless signal to and from the access point 52.

However, the access point 52 in FIG. 3 is typically installed in a building such as a home or office and, particularly, installed at a high place in the building, i.e., at a ceiling to expand the wireless LAN service area. Accordingly, it is difficult to install the access point 52 for providing the wireless LAN service to a computer device of a user. Moreover, the access point 52 and the cable model 51 are connected to each other through the cable C, which may affect the interior appearance of the building. Further, the tap-off device 41 and the cable modem 51 are connected to each other through the cable C over a predetermined length, which may cause signal loss.

At present, the wireless LAN service is provided only to a home, office, or public place that applies for the service, and thus a system which can provide the wireless LAN service anywhere is required to expand the wireless LAN service.

### DISCLOSURE OF INVENTION

### Technical Problem

The present invention has been made in an effort to solve the above-described problems associated with prior art. Accordingly, it is an object of the present invention to provide a tap-off device capable of providing a wireless LAN service, in which a tap-off device of an existing CATV network is configured to perform an access point function so as to solve the problem caused by installing an access point in a building to receive a wireless LAN service and so as to allow a user to receive the wireless LAN service anywhere without spatial limitations.

### Solution to Problem

In one aspect, the present invention provides a wireless tap-off device capable of providing a wireless local area network (LAN) service, the wireless tap-off device being used in a wireless LAN system for providing the wireless LAN service to a plurality of users' computer devices each provided with a wireless LAN card through a tap-off device of a cable television (CATV) network, the wireless tap-off device comprising: a plurality of connectors; a filtering processing unit which filters and distributes a CATV signal and AC power applied from the CATV network and transmits an input CATAV signal to the CATV network; a splitter which distributes CATV signals applied from the filtering processing unit to the respective connectors, combines CATV signals applied from the respective connectors, and transmits the combined signal to the filtering processing unit; a cable modem which is connected to at least one connector, converts a CATV signal applied from the corresponding connector into an Ethernet signal, outputs the converted signal, converts an Ethernet signal into a CATV signal, and transmits the converted signal to the connector; an access point which converts an Ethernet signal applied from the cable modem into a wireless signal, transmits the converted signal to the computer device through an antenna in a wireless manner, converts a wireless signal applied from the computer device into an Ethernet signal, and provides the converted signal to the cable modem; a DC power supply which converts the AC power applied from the filtering processing unit into DC power and supplies the DC power as a driving power to the cable modem and the access point; a switching unit which controls the driving power, supplied to the cable modem or the access point when a reset signal is received, to reboot the cable modem or the access point, wherein at least one of the cable modem and the access point may determine whether there is an abnormality in data flow by performing a Packet Internet Groper (PING) on a gateway in an Internet Protocol (IP) network and, if it is determined that there is an abnormality, output a reset signal.

Moreover, the wireless tap-off device of the present invention may further comprise a wireless receiver which receives a reset command from an administrator in a wireless manner and outputs a reset signal, wherein the switching unit may reboot the cable modem or the access point when the reset signal is received from the wireless receiver.

Furthermore, the wireless tap-off device of the present invention may further comprise a voice over Internet protocol (VoIP) wireless processing means for providing a wireless VoIP service, wherein the cable modem may provide a VoIP interface between the connector and the VoIP wireless processing means.

### ADVANTAGEOUS EFFECTS OF INVENTION

According to the present invention having the above-described configuration, it is possible to easily construct a broadband wireless LAN system which can allow a user to receive a wireless LAN service anywhere anytime by simply replacing a portion of each of a plurality of tap-off devices, which are installed all over the country at regular intervals at present, to provide a wireless access point function.

Moreover, according to the present invention, the AC power supplied from a CATV network is converted into DC power and supplied as a driving power to a cable modem and an access point for providing the wireless LAN service, and thus it is not required to provide an additional device for the power supply. Furthermore, it is possible to construct a wireless LAN system, in which a wireless LAN signal of the CATV network is directly connected to the cable modem, thereby preventing signal loss and improving signal quality.

In addition, according to the present invention, the cable modem or the access modem is configured to be automatically rebooted in the event of an abnormality in the network or forcibly rebooted by an administrator of the network in a wireless manner, thereby allowing the administrator to easily administer the network.

### BRIEF DESCRIPTION OF DRAWINGS

FIG. 1 is a schematic diagram showing the configuration of a conventional wireless LAN system.

FIG. 2 is a block diagram showing the internal configuration of a tap-off device of FIG. 1.

FIG. 3 is a schematic diagram showing the internal configuration of a subscriber terminal 50 of FIG. 1.

FIG. 4 is a schematic diagram showing the configuration of a wireless LAN system in which a wireless tap-off device 100 in accordance with an exemplary embodiment of the present invention is employed.

FIG. 5 is a block diagram showing the internal configuration of the wireless tap-off device 100 of FIG. 4.

FIG. 6 is a block diagram showing an example of the configuration of a cable modem 160 of FIG. 5.

FIG. 7 is a block diagram showing an example of the configuration of an access point 170 of FIG. 5.

FIG. 8 is a schematic diagram showing the appearance of the wireless tap-off device 100 of FIG. 5.

FIG. 9 is a schematic diagram showing the configuration of a wireless tap-off device in accordance with another exemplary embodiment of the present invention.

### MODE FOR THE INVENTION

Hereinafter, preferred embodiments in accordance with the present invention will be described with reference to the accompanying drawings. The preferred embodiments are provided so that those skilled in the art can sufficiently understand the present invention, but can be modified in various forms and the scope of the present invention is not limited to the preferred embodiments.

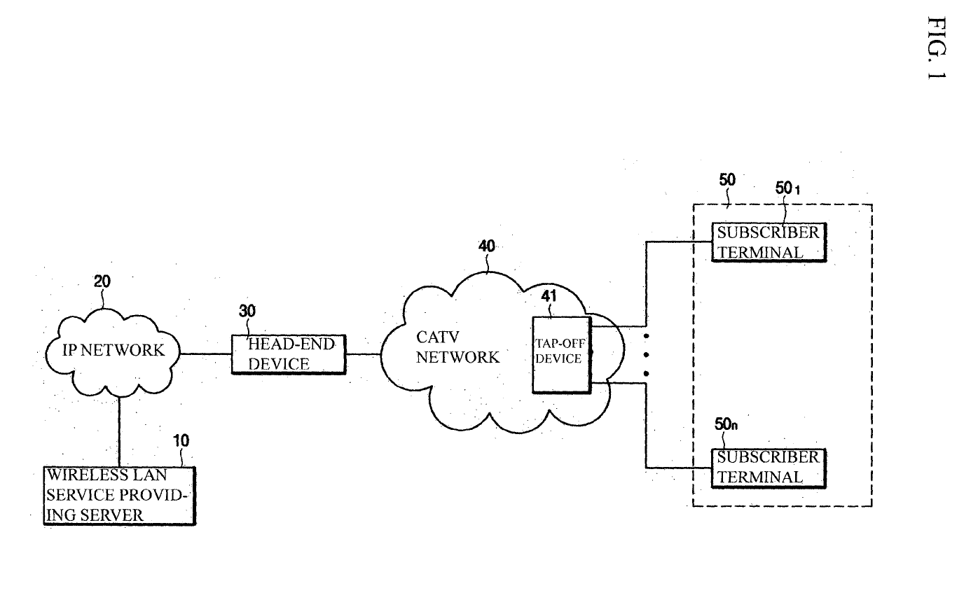

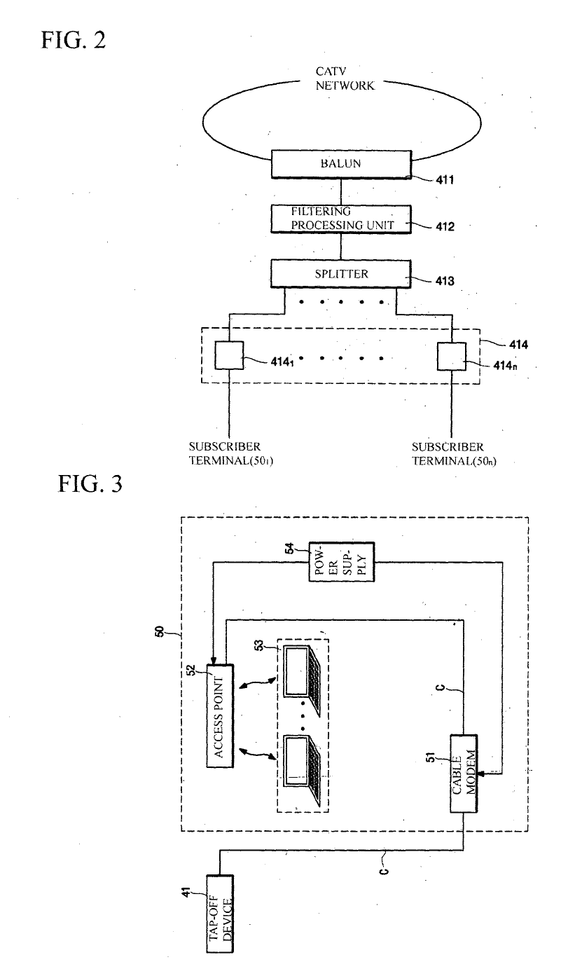

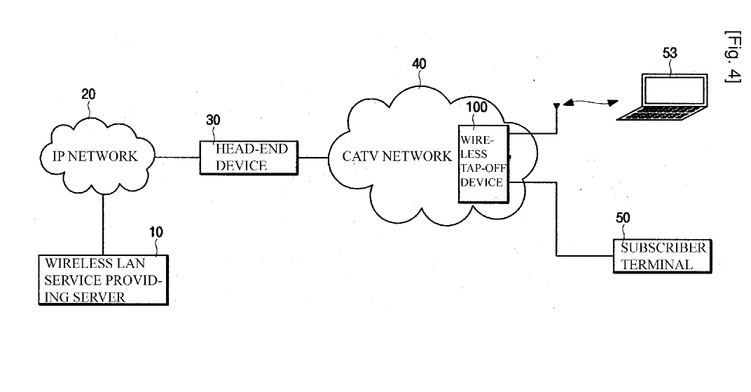

FIG. 4 is a schematic diagram showing the configuration of a wireless LAN system in which a wireless tap-off device 100 capable of providing a wireless LAN service in accordance with an exemplary embodiment of the present invention is employed, in which the same components as those shown in FIG. 1 are denoted by the same reference numerals and their detailed description will be omitted.

In a conventional wireless LAN system shown in FIG. 1, a tap-off device 41 is provided at a terminal of a CATV network 40, and a subscriber terminal 50 is connected to the tap-off deice 41. Moreover, an access point 52 for providing a wireless LAN service is installed at the subscriber terminal 50. Thus, in the conventional system, the installation of the access point 52 causes inconvenience, and the wireless LAN service area is limited within a certain range.

In FIG. 4, a wireless tap-off device 100 is provided at the terminal of the CATV network 40. The wireless tap-off device 100 includes an access point to provide a wireless LAN service. The wireless tap-off device 100 is preferably installed in a position where the transmission and reception of frequency signals is facilitated, such as the top of a telephone pole, and a plurality of wireless tap-off devices are arranged at regular intervals. Thus, according to the present invention, a user can receive the wireless LAN service without limitations using a terminal device provided with a wireless LAN card within an area where the CATV network 40 is installed.

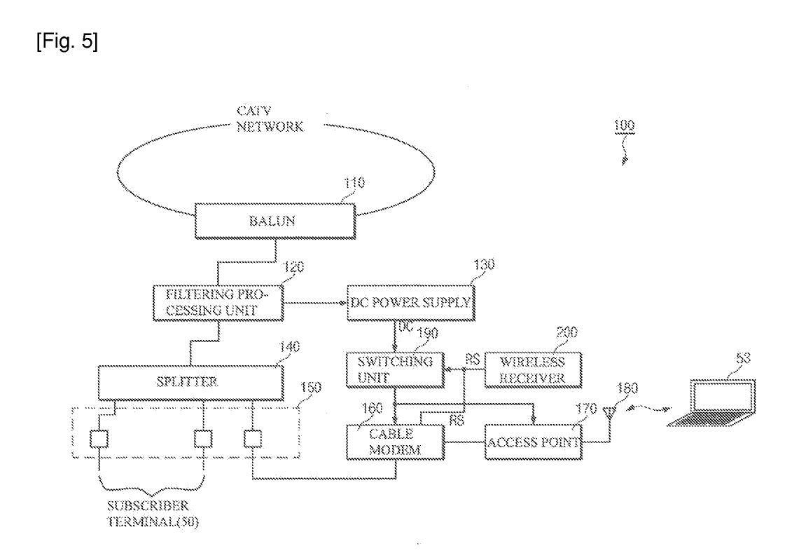

FIG. 5 is a block diagram showing the internal configuration of the wireless tap-off device 100 of FIG. 4.

As shown in FIG. 5, the wireless tap-off device 100 comprises a balun 110, a filtering processing unit 120, a DC power supply 130, a splitter 140, a plurality of connectors 150, a cable modem 160, an access point 170, an antenna 180, a switching unit 190, and a wireless receiver 200.

The balun 110 distributes a CATV signal and AC power applied through a cable that constitutes the CATV network to another tap-off device and the filtering processing unit 120. Here, the CATV signal includes a broadcasting signal and a wireless LAN signal, and the AC power is, for example, 60 V or 90V AC power supplied through a coaxial cable.

The filtering processing unit 120 filters the CATV signal and AC power based on the signals applied from the balun 110 and outputs the CATV signal to the splitter 140 and the AC power to the DC power supply 130. Moreover, the filtering processing unit 120 removes noise from the CATV signal applied from the splitter 140 and transmits the resulting signal to the balun 110.

The DC power supply 130 converts the 60 V or 90 V AC power applied from the filtering processing unit 120 into 12 V DC power, for example, and supplies the 12 V DC power as a driving power to the cable modem 160 and the access point 170 through the switching unit 190.

The splitter 140 distributes the CATV signal applied from the filtering processing unit 120 to the plurality of connectors 150. Moreover, the splitter 140 combines the CATV signals applied from the respective connectors 150 and transmits the combined signal to the filtering processing unit 120. Here, the splitter 140 includes a plurality of output terminals, which may be changed to correspond to the number of connectors 150, and generally includes sixteen output terminals.

A predetermined number of the plurality of connectors 150 are connected to the subscriber terminals 50 via cable in a typical manner, and the remaining number of the connectors 150 are connected to the cable modem 160. Although the number of the connectors 150 connected to the cable modem 160 is one as shown in FIG. 5, the number of the connectors 150 connected to the cable modem 160 may be at least one. The number of the connectors 150 for the cable modem 160 may be set arbitrarily by an administrator of the network.

The cable modem 160 converts a wireless LAN signal in the form of a CATV signal applied from the connector 150 into an Ethernet signal and provides the converted signal to the access point 170. Moreover, the cable modem 160 converts an Ethernet signal applied from the access point 170 into a CATV signal and transmits the converted signal to the connector 150. Here, the cable modem 160 has a MAC address clear function and is preferably configured to meet the Data-Over-Cable Service Interface Specifications (DOCSIS) 1.0, 1.1 and 2.0 and other non-standard specifications.

Moreover, the cable modem 160 determines whether the data flow is smoothly made by performing a Packet Internet Groper (PING) and, if it is determined that the data flow is not smooth, generates and outputs a reset signal RS. The output reset signal RS is provided to the switching unit 190.

The access point 170 converts an Ethernet signal applied from the cable modem 160 into a wireless signal and outputs the converted signal through the antenna 180 in a wireless manner. Moreover, the access point 170 converts a wireless signal received through the antenna 180 into an Ethernet signal and provides the converted signal to the cable modem 160. Here, the access point 170 supports IEEE 802. 11a, 11b, 11g and 802.1x and is preferably configured to perform cell formation and roaming between cells.

When receiving the reset signal RS from the cable modem 160 or the wireless receiver 200, the switching unit 190 cuts off the DC power, which is supplied to the cable modem 160 or to the cable modem 160 and the access point 170, for a predetermined time, thereby rebooting the cable modem 160 and the access point 170.

Each of the cable modem 160 and the access point 170 performs data processing with a built-in processor. The cable modem 160 processes the data flow between the connector 150 and the access point 170, and the access point 170 processes the data flow between the cable modem 160 and a wireless terminal device 53. During the data flow, the data flow may be interrupted for various reasons. In this case, the use of the network is impossible.

That is, there may be a case where the command processing by the processor is impossible due to overload or malfunction of the processor or a case where the command processing by the processor is possible but the data processing is impossible. Even in any case, an effective method to overcome these inactive states is to reset the cable modem 160 by turning off the cable modem 160 and turning on again.

As such, the cable modem 160 determines whether there is an abnormality in the data flow by performing the PING at regular intervals and, in the event of an abnormality, outputs the reset signal RS to temporarily turn off the switching unit 190, thereby resetting the cable modem 160.

Meanwhile, in the case where the processor cannot execute the command processing itself, it is required to forcibly reset the cable modem 160 from the outside. The wireless receiver 200 is to cope with these inactive states. As mentioned above, the wireless tape-off device in accordance with the exemplary embodiment of the present invention is installed at a high place such as the top of a telephone pole. Accordingly, it is not easy for the administrator to reset the cable modem 160 provided in the wireless tap-off device.

Although not shown in the figures, a separate terminal device for allowing the administrator to reset the cable modem 160 is provided in this exemplary embodiment of the present invention. This terminal device communicates with the wireless receiver 200 with an RF or IR signal. When the administrator operates a reset key provided in the terminal device, a reset signal is transmitted to the wireless receiver 200, and the wireless receiver 200 supplies a reset signal RS to the switching unit 190 based on the received reset signal. When receiving the reset signal RS, the switching unit 190 controls the power supply to the cable modem 160 and the access point 170, thereby rebooting these devices.

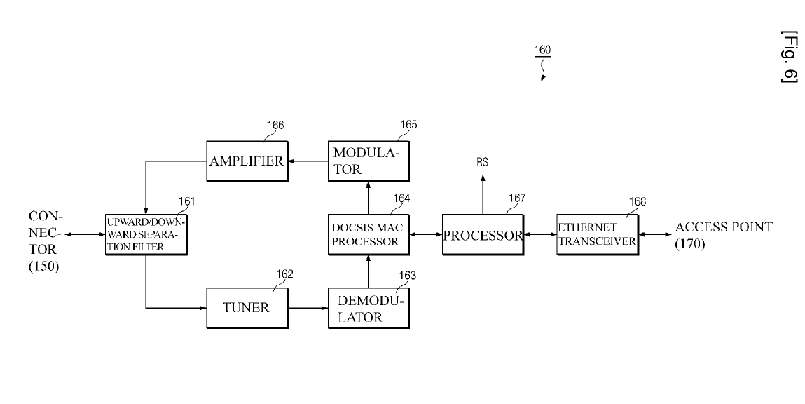

FIG. 6 is a block diagram showing an example of the configuration of a cable modem 160 of FIG. 5.

In FIG. 6, a downlink signal of 88 MHz to 1 GHz according to the DOCSIS standard, for example, received from the splitter 140, i.e., the CATV network 40, is applied to a tuner 162 through an upward/downward separation filter 161. Then, the tuner 162 converts the received signal into an intermediate frequency signal of 6 MHz, for example, and transmits the converted signal to a demodulator 163. The downlink signal demodulated by the demodulator 163 is applied to a processor 167 by a DOCSIS MAC processor 164. The DOCSIS MAC processor 164 performs data processing according to the DOCSIS standard.

The processor 167 converts data applied from the DOCSIS MAC processor 164 into Ethernet frame data and transmits the converted data to the access point 170 through an Ethernet transceiver 168.

Meanwhile, Ethernet data received from the access point 170 is provided to the processor 167 through the Ethernet transceiver 168, and the processor 167 converts Ethernet frame data into frame data according to the DOCSIS standard. The converted data is provided to a modulator 165 by the DOCSIS MAC processor 164. The modulator 165 converts data applied from the DOCSIS MAC processor 164 into a frequency signal of 5 to 65 MHz, for example, and the modulated signal is transmitted to the CATV network 40 through an amplifier 166 and the upward/downward separation filter 161.

In particular, the processor 167 performs the PING at regular intervals. That is, the processor 167 generates a PING command at regular intervals and transmits the PING command to a gateway (not shown) in the IP network 20. The PING command packet is transmitted to the IP network 20 through the DOCSIS MAC processor 164 and the modulator 165.

If there is no reply within a predetermined time, for example, within 60 seconds, after transmitting the PING command, the processor 167 determines that there is an abnormality in the network. Moreover, if this abnormality occurs three times in succession, for example, the processor 167 outputs a reset signal RS, thereby rebooting the cable modem 160.

As mentioned above, the reset signal RS output from the processor 167 is applied to the switching unit 190, and the switching unit 190 turns off the power supply to the cable modem 160 and the access point 170 and turns on again, thereby rebooting these devices.

Moreover, the PING may be performed by the access point 170, instead of the cable modem 160, or by the cable modem 160 and the access point 170 at the same time.

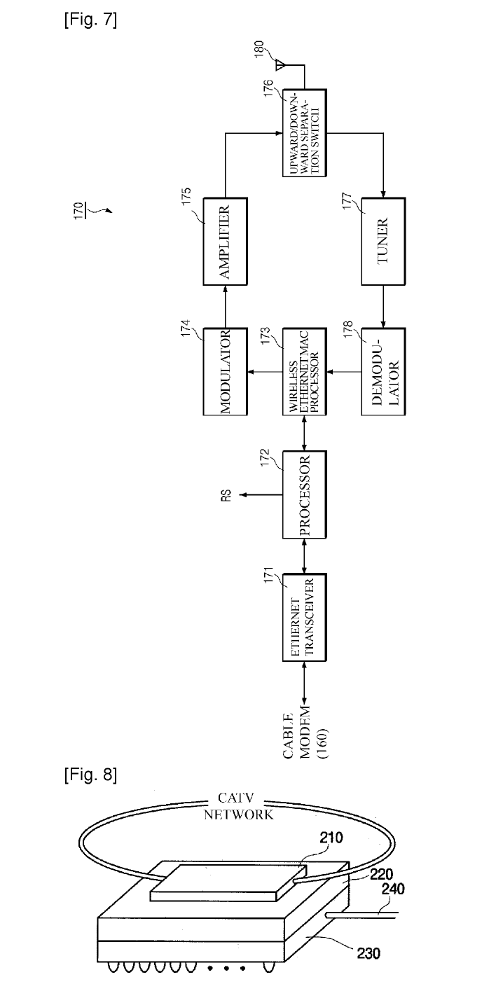

FIG. 7 is a block diagram showing an example of the configuration of the access point 170.

In FIG. 7, a processor 172 is connected to the cable modem 160 through an Ethernet transceiver 171. The processor 172 executes applications of the L2 and L3 layers including virtual IP assignment and roaming support for the user's wireless terminal device and performs a PING. The PING is performed in the same manner as the above-described cable modem 160. That is, the processor 172 generates a PING command at regular intervals and transmits the PING command to a gateway (not shown) in the IP network 20. If an abnormality in which there is no reply within a predetermined time, for example, within 60 seconds occurs three times in succession, for example, the processor 172 outputs a reset signal RS. Although not shown in FIG. 7, the reset signal RS output from the processor 172 will be applied to the switching unit 190.

In the above configuration, the reset signal RS may be generated by any one or all of the cable modem 160, the access point 170, and the wireless receiver 200.

A wireless Ethernet MAC processor 173 performs data processing according to a wireless Ethernet protocol. A downlink signal output from the wireless Ethernet MAC processor 173 is provided to a modulator 174. The modulator 174 converts the input downlink signal into a frequency signal of 2.4 GHz or 5 GHz, for example, and outputs the converted signal. The generated frequency signal is transmitted to the user's wireless terminal device through an amplifier 175, an upward/downward separation switch 176, and an antenna 180.

The frequency signal of 2.4 GHz or 5 GHz, for example, received through the antenna 180 is applied to a tuner 177 through the upward/downward separation switch 176 and converted into an intermediate frequency signal. The intermediate frequency signal is then demodulated by a demodulator 178 and applied to the wireless Ethernet MAC processor 173. This uplink signal is then provided to the cable modem 160 through the processor 172 and the Ethernet transceiver 171.

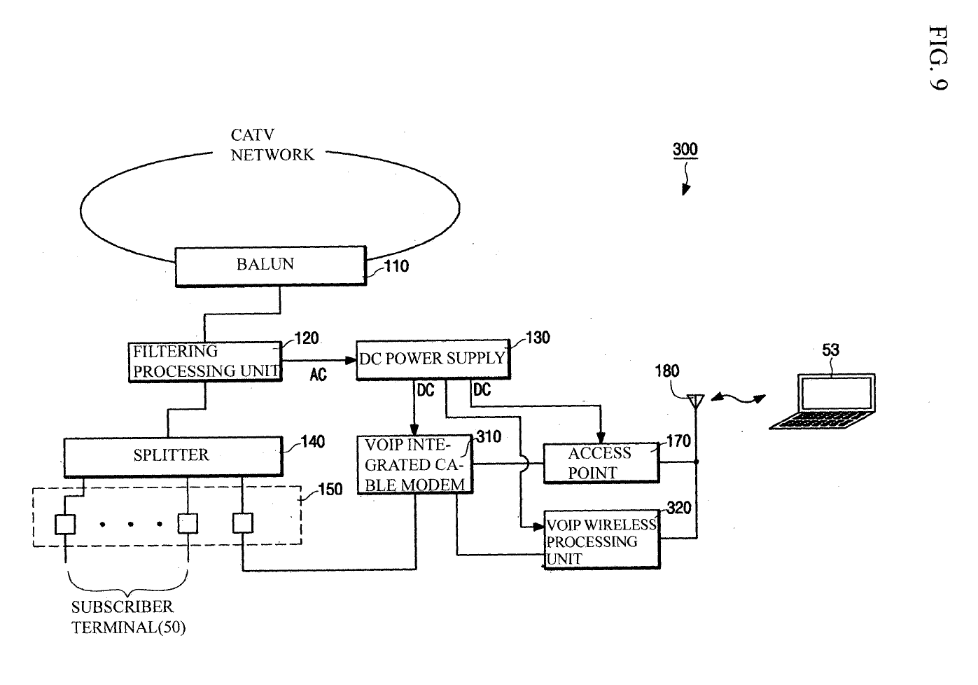

Meanwhile, as shown in FIG. 5, the wireless tap-off device in accordance with the exemplary embodiment of the present invention comprises four separable modules. That is, FIG. 8 schematically shows the appearance of the wireless tap-off device 100. In the figures, the wireless tap-off device 100 comprises an input/output block 210 composed of the balun 110 of FIG. 5 and transmitting and receiving a signal to and from the CATV network, a filtering block 220 composed of the filtering processing unit 120 and the DC power supply 130 of FIG. 5, a path setting block 230 composed of the splitter 140, the connectors 150, the switching unit 190, the cable modem 160, and the access point 170, and an antenna block 240. Here, the respective blocks may be connected to each other via cable.

When the tap-off device 100 in accordance with the exemplary embodiment of the present invention is installed at a telephone pole or repaired, the filtering block 220 and the path setting block 230 are replaced in a state where the input/output block 210 of a conventional tap-off device connected to a cable of the CATV network, and the antenna block 240 is connected to the path setting block 230. That is, the tap-off device 100 in accordance with the exemplary embodiment of the present invention can be easily modified and repaired from the previously installed tap-off device.

The operation of the tap-off device 100 having the above-described configuration for providing the wireless LAN service will be described below.

First, when a user requests to access the Internet through his or her wireless terminal device 53, the user's request is converted into a wireless signal through a wireless LAN card of the wireless terminal device 53 and applied to the access point 170 through the antenna 180 of the tap-off device 100. The access point 170 converts the access request signal received through the antenna 180 into an Ethernet signal and provides the converted signal to the cable modem 160. The cable modem 160 converts the Ethernet signal applied from the access point 170 into a CATV signal and provides the converted signal to the splitter 140 through the connector 150. The splitter 140 combines the CATV signals applied from the respective connectors 150 and transmits the combined signal to the balun 110 through the filtering processing unit 120. Then, the balun 110 transmits the combined signal to the head-end device 30 through the CATV network 40 connected through a coaxial cable, for example. The head-end device 30 converts access information in the form of the CATV signal applied from the CATV network 40 into a signal corresponding to the IP network 20 and provides the converted signal to a service providing server 10 through the IP network 20. Then, the corresponding service providing server 10 provides information corresponding to the access request to the wireless terminal device of the user who requests to access the Internet in a manner opposite to the above-described manner, of which detailed description will be omitted.

Moreover, in this operating state, the processors 167 and 172 provided in the cable modem 160 and the access point 170, respectively, determine whether there is an abnormality in the network by performing the PING at regular intervals and, in the event of an abnormality, provide a reset signal RS to the switching unit 190, thereby rebooting the cable modem 160 and the access point 170.

Meanwhile, a voice over Internet protocol (VoIP) technology for performing voice transmission such as a telephone call through the IP network has recently been developed to provide an Internet telephone service, for example. FIG. 9 shows the configuration of a wireless tap-off device in accordance with another exemplary embodiment of the present invention, which is configured to provide a VoIP service. As shown in FIG. 9, a wireless tap-off device 300 further comprises an integrated cable modem 310, which is configured to provide the wireless LAN service and the VoIP service, and a VoIP wireless processing unit 320 which transmits and receives a VoIP signal to and from the cable modem 310, converts the VoIP signal into a wireless signal of 900 MHz or 2.4 GHz, transmits the converted signal through the antenna 180, converts a signal received through the antenna 180 into a VoIP signal, and transmits the converted signal to the integrated cable modem 310. Therefore, the user can receive the VoIP service through his or her terminal, for example, a voice communication terminal using a wireless signal of 900 MHz or 2.4 GHz.

Moreover, in this exemplary embodiment, a switching unit for controlling the DC power supplied to the integrated cable modem 310, the access point 170, and the VoIP wireless processing unit 320 may be installed at a DC power output terminal of the DC power supply 130, and any one or all of the integrated cable modem 310 and the access point 170 may perform the PING to generate the reset signal RS.

### INDUSTRIAL APPLICABILITY

As described above, according to the present invention, it is possible to easily construct the wireless LAN system by configuring each of the tap-off devices, which are installed all over the country at regular intervals at present, to provide the wireless access point function, thereby allowing the user to receive the wireless LAN service anywhere anytime.

Moreover, the AC power supplied from the CATV network is converted into DC power and supplied as a driving power to the cable modem and the access point for providing the wireless LAN service, and thus it is not required to provide a separate DC power line or an Ethernet power supply.

Furthermore, it is possible to construct a broadband wireless LAN system by simply replacing a portion of the tap-off device of the existing CATV network.

In addition, since the wireless LAN signal of the CATV network is directly connected to the cable modem, it is possible to prevent signal loss and deterioration of signal quality, which are caused when the wireless LAN signal passes through the cable over a predetermined length.

Additionally, the cable modem or the access modem is configured to be automatically rebooted in the event of an abnormality in the network or forcibly rebooted by the administrator in a wireless manner, thereby allowing the administrator to easily administer the network.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A wireless tap-off device capable of providing a wireless local area network (LAN) service, the wireless tap-off device being used in a wireless LAN system for providing the wireless LAN service to a plurality of users' computer devices each provided with a wireless LAN card through a tap-off device of a cable television (CATV) network, the wireless tap-off device comprising:
a plurality of connectors;
a filtering processing unit which filters and distributes a CATV signal and AC power applied from the CATV network and transmits an input CATAV signal to the CATV network;
a splitter which distributes CATV signals applied from the filtering processing unit to the respective connectors, combines CATV signals applied from the respective connectors, and transmits the combined signal to the filtering processing unit;
a cable modem which is connected to at least one connector, converts a CATV signal applied from the corresponding connector into an Ethernet signal, outputs the converted signal, converts an Ethernet signal into a CATV signal, and transmits the converted signal to the connector;
an access point which converts an Ethernet signal applied from the cable modem into a wireless signal, transmits the converted signal to the computer device through an antenna in a wireless manner, converts a wireless signal applied from the computer device into an Ethernet signal, and provides the converted signal to the cable modem;
a DC power supply which converts the AC power applied from the filtering processing unit into DC power and supplies the DC power as a driving power to the cable modem and the access point; and
a switching unit which controls the driving power, supplied to the cable modem or the access point when a reset signal is received, to reboot the cable modem or the access point,
wherein at least one of the cable modem and the access point determines whether there is an abnormality in data flow by performing a Packet Internet Groper (PING) on a gateway in an Internet Protocol (IP) network and, if it is determined that there is an abnormality, outputs a reset signal.

2. The wireless tap-off device of claim 1, further comprising a wireless receiver which receives a reset command from an administrator in a wireless manner and outputs a reset signal, wherein the switching unit reboots the cable modem or the access point when the reset signal is received from the wireless receiver.

3. The wireless tap-off device of claim 1, further comprising a voice over Internet protocol (VoIP) wireless processing means for providing a wireless VoIP service, wherein the cable modem provides a VoIP interface between the connector and the VoIP wireless processing means.
